(19) United States
(12) Patent Application Publication
(10) Pub. No.: US 2015/0231730 A1
(43) Pub. Date: Aug. 20, 2015

(54) RESISTANCE SPOT WELDING STEEL AND ALUMINUM WORKPIECES WITH PROTUBERANCE

(71) Applicant: GM GLOBAL TECHNOLOGY OPERATIONS LLC, Detroit, MI (US)

(72) Inventors: David Yang, Shanghai (CN); David R. Sigler, Shelby Township, MI (US)

(73) Assignee: GM GLOBAL TECHNOLOGY OPERATIONS LLC, Detroit, MI (US)

(21) Appl. No.: 14/181,955

(22) Filed: Feb. 17, 2014

(51) Int. Cl. B23K 11/20; B23K 11/30; B23K 11/11

(52) U.S. Cl. CPC B23K 11/20; B23K 11/115; B23K 11/3009

(57) ABSTRACT

A method of resistance spot welding a steel workpiece and an aluminum or aluminum alloy workpiece (“aluminum workpiece”) together includes several steps. In one step a workpiece stack-up is provided. The workpiece stack-up includes a steel workpiece and an aluminum workpiece. Another step involves forming a protuberance in the steel workpiece. In another step a first and second welding electrode is provided. Yet another step involves clamping the first and second welding electrodes over the workpiece stack-up and over the protuberance. And another step involves performing one or more individual resistance spot welds to the workpiece stack-up.

### TECHNICAL FIELD

The technical field of this disclosure relates generally to resistance spot welding and, more particularly, to resistance spot welding a steel workpiece and an aluminum (Al) or aluminum alloy workpiece together.

### BACKGROUND

Resistance spot welding is a process used in a number of industries for joining two or more metal workpieces together. The automotive industry, for instance, often uses resistance spot welding to join sheet metal layers together during the manufacture of a vehicle door, hood, trunk lid, or lift gate, among other vehicle components. Multiple individual resistance spot welds are typically made along a periphery of the sheet metal layers or at some other location to ensure the vehicle part is structurally sound. While spot welding has typically been performed to join together certain similarly-composed metal workpieces—such as steel-to-steel and aluminum alloy-to-aluminum alloy—the desire to incorporate lighter weight materials into a vehicle platform has created interest in joining steel workpieces to aluminum or aluminum alloy (hereafter collectively “aluminum” for brevity) workpieces by resistance spot welding.

Resistance spot welding, in general, relies on the resistance to the flow of electrical current through contacting metal workpieces and across their faying interface to generate heat. The faying interface is usually the confronting and abutting interface of the workpieces. To carry out a resistance welding process, a pair of opposed welding electrodes are typically clamped at aligned spots on opposite sides of the workpieces at a predetermined weld site. A momentary electrical current is then passed through the workpieces from one welding electrode to the other. Resistance to the flow of this electrical current generates heat within the workpieces and at their faying interface. When the metal workpieces being welded are a steel workpiece and an aluminum workpiece, the heat generated at the faying interface initiates a molten weld pool in the aluminum workpiece. This molten weld pool wets the adjacent surface of the steel workpiece and, upon stoppage of the current flow, solidifies into a weld nugget. After the spot welding process has been completed, the welding electrodes are retracted from their respective workpiece surfaces, and the spot welding process is repeated at another weld site.

Resistance spot welding a steel workpiece and an aluminum workpiece together presents certain challenges. These metals have considerable dissimilarities that tend to hamper the spot welding process. For one, aluminum workpieces have oxide layers covering their surfaces. The oxide layers are created by processes carried out in mill operations (e.g., annealing, solution treatment, and casting) as well as exposure to the environment. When existing at the faying interface, it has been found that the oxide layers can disrupt the molten weld pool material initiated in the aluminum workpiece from wetting the adjacent steel workpiece surface in the midst of spot welding. In general, proper wetting helps ensure overall strength and integrity of an established joint between workpieces.

Furthermore, steel has a relatively high melting point and a relatively high resistivity, while aluminum has a relatively low melting point and a relatively low resistivity. As a result of these differences, aluminum melts more quickly and at a much lower temperature than steel during the flow of electrical current in spot welding. Aluminum also cools down more quickly than steel after the cessation of electrical current flow. Controlling heat balance between the two metals so that a molten weld pool can be rapidly initiated, grown in a controlled manner, and then solidified to produce a structurally sound weld nugget can therefore be challenging. It has been found that, using standard industry practices typically used for resistance spot welding steel-to-steel or aluminum-to-aluminum, cooling of the molten weld pool is relatively rapid and uncontrolled, thus, forming defects in the ultimately-formed weld nugget. The cooling drives the defects such as shrinkage, gas porosity, oxide residue, and micro-cracking toward the faying interface. Additionally, elevated temperatures in the steel workpiece due to its relatively higher resistance are conducive to the growth of brittle iron (Fe)—Al intermetallic layers at the faying interface.

The above conditions where both weld defects and brittle intermetallic layers co-exist at and along the faying interface have been shown to reduce the peel strength of the ultimately-formed weld nugget and weaken the overall integrity of the established joint between the workpieces.

### SUMMARY OF THE DISCLOSURE

A method of resistance spot welding a steel workpiece and an aluminum workpiece together includes several steps. The exact order of the steps can vary. In one step, a workpiece stack-up is provided. The workpiece stack-up includes a steel workpiece and an aluminum workpiece. In another step, a protuberance is formed in the steel workpiece. The formation can involve various processes, depending upon the protuberance. In yet another step, a first and second welding electrode is provided. The first welding electrode generally confronts the steel workpiece at the protuberance, and the second welding electrode generally confronts the aluminum workpiece. In another step, the first and second welding electrodes are clamped over the workpiece stack-up and over the protuberance. And in another step, one or more individual resistance spot welds are performed to the workpiece stack-up and at the protuberance.

A welding electrode and workpiece stack-up assembly for resistance spot welding includes a first welding electrode, a second welding electrode, a steel workpiece, and an aluminum workpiece. The steel workpiece generally confronts the first welding electrode and has a protuberance jutting above a surface of the steel workpiece. A largest extent of the protuberance has a value that is less than a diameter of a weld face of the first welding electrode. The aluminum workpiece generally confronts the second welding electrode on one side of the workpiece, and generally confronts the steel workpiece on an opposite side of the aluminum workpiece.

### BRIEF DESCRIPTION OF THE DRAWINGS

FIG. 1 is a side view of a resistance spot welding assembly;

FIG. 2 is a microstructure of a weld nugget formed via a resistance spot welding process without using a protuberance detailed in the description below;

FIG. 3 is a photograph of a steel workpiece at a resistance spot weld after an aluminum workpiece had been peeled off of the steel workpiece during testing, the steel workpiece lacking a protuberance detailed in the description below;

FIG. 4 is a side view of welding electrodes and workpieces, one of the workpieces having an embodiment of a protuberance formed therein;

FIG. 5 is a side view of welding electrodes and workpieces, one of the workpieces having another embodiment of a protuberance formed therein;

FIG. 6 is a microstructure of a weld nugget formed via a resistance spot welding process using a protuberance detailed in the description below;

FIG. 7 is a photograph of a steel workpiece at a resistance spot weld after an aluminum workpiece had been peeled off of the steel workpiece during testing, the steel workpiece having a protuberance detailed in the description below;

FIG. 8 is a graph depicting the average weld strength minimally required for an aluminum resistance spot weld, as well as the average weld strength resulting from the use of a protuberance detailed in the description below;

FIG. 9A is a side view of one step of forming a protuberance in a workpiece; and

FIG. 9B is a side view of another step of forming the protuberance of FIG. 9A.

### DETAILED DESCRIPTION

The methods and assemblies detailed in this description resolve several challenges encountered when resistance spot welding is performed on a workpiece stack-up that includes an aluminum workpiece and a steel workpiece. Though described in greater detail below, in general the methods and assemblies described cause penetration through oxide layers present on the aluminum workpiece and thereby help ensure proper wetting between the aluminum and steel workpieces. The methods and assemblies also alter the solidification behavior of a produced weld pool and thereby limit or altogether preclude the dissemination of defects laterally along a faying interface of the workpiece stack-up. Further, the methods and assemblies can minimize the size and thickness of Fe—Al intermetallic layers formed at the faying interface, and can hinder the propagation of micro-cracks at the faying interface. Of course, other improvements are possible and not all of these improvements need be exhibited in all of the methods and assemblies detailed below. Taken together or alone, these measures help maintain suitable peel strength of a solidified weld nugget between the aluminum and steel workpieces, and help ensure the overall strength and integrity of the established joint between the workpieces.

The term “workpiece” and its steel and aluminum variations is used broadly in this description to refer to a sheet metal layer, a casting, an extrusion, or any other piece that is resistance spot weldable. The term “aluminum” as used in this description includes aluminum materials and aluminum alloy materials, as detailed below. Furthermore, value ranges provided in this description are meant to include their outer and end limits. Lastly, although described in the context of vehicle body parts, the methods and assemblies detailed may be suitable in other contexts such as industrial equipment applications.

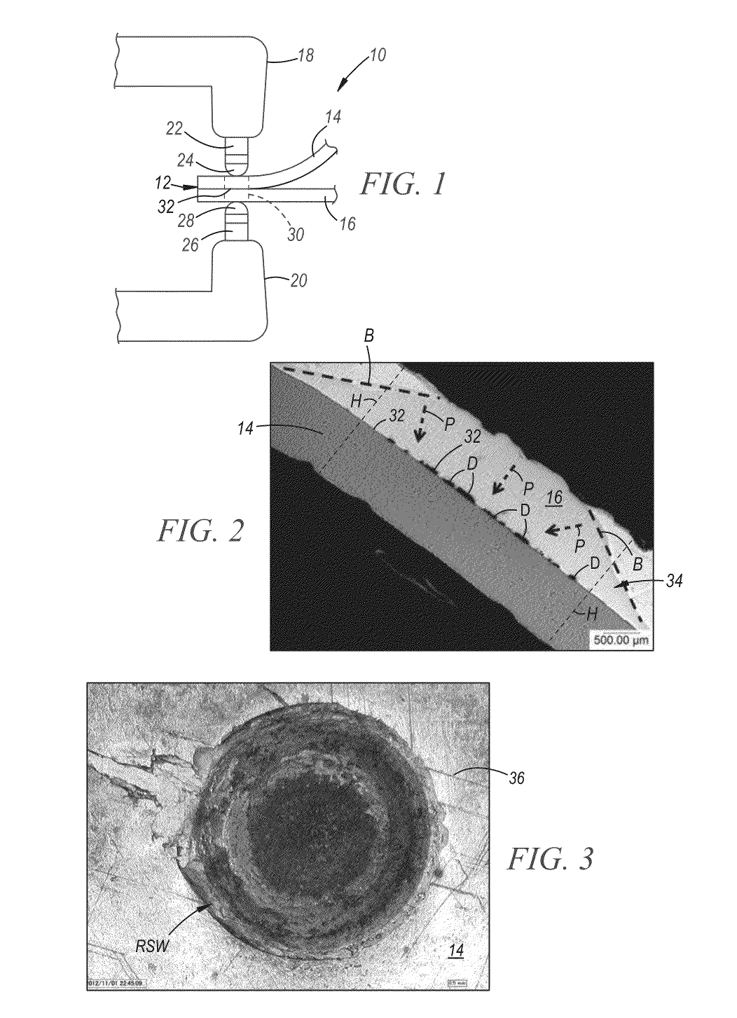

FIG. 1 shows one example of a welding electrode assembly 10 that can be used to resistance spot weld a workpiece stack-up 12 that includes a steel workpiece 14 and an aluminum workpiece 16 that are overlaid on each other. Though not shown in FIG. 1, instead of two workpieces the workpiece stack-up 12 could include a single aluminum workpiece and a pair of steel workpieces, among other possibilities. The steel workpiece 14 can be a galvanized low carbon steel, a galvanized advanced high strength steel (AHSS), an aluminum coated steel, a low carbon steel, a bare steel, or another type of steel. Some more specific kinds of steels that can be used as the steel workpiece 14 include, but are not limited to, interstitial-free (IF) steel, dual-phase (DP) steel, transformation-induced plasticity (TRIP) steel, and press-hardened steel (PHS). The aluminum workpiece 16, on the other hand, can be an aluminum-magnesium alloy, an aluminum-silicon alloy, an aluminum-magnesium-silicon alloy, an aluminum-zinc alloy, an aluminum metal, or another type of aluminum. Some more specific kinds of aluminum that can be used as the aluminum workpiece 16 include, but are not limited to, 5754 aluminum-magnesium alloy, 6022 aluminum-magnesium-silicon alloy, 7003 aluminum-zinc alloy, and Al-10Si—Mg aluminum die casting alloy. In addition, the aluminum alloys may be coated with zinc or conversion coatings typically used to improve adhesive bond performance. Optionally, the workpieces may contain weld-through adhesives or sealers that are normally used in resistance spot welding operations. Each of the steel and aluminum workpieces 14, 16 can have a thickness dimension that ranges between approximately 0.3 millimeters (mm) and 6.0 mm, between approximately 0.5 mm and 4.0 mm, and more narrowly between 0.6 mm and 2.5 mm; other thickness dimensions are possible. The term “approximately” is used herein to mean within the generally acceptable manufacturing tolerances in the art.

Still referring to FIG. 1, the welding electrode assembly 10 is typically a part of a larger automated welding operation that includes a first welding gun arm 18 and a second welding gun arm 20 mechanically and electrically configured to repeatedly form resistance spot welds, as is generally understood in resistance spot welding technologies. As with other components shown in the figures, the welding gun arms 18, 20 are shown schematically and their exact design and construction will vary as will be known by those skilled in the art. The first welding gun arm 18 can have a first electrode holder 22 that secures a first welding electrode 24, and likewise the second welding gun arm 20 can have a second electrode holder 26 that secures a second welding electrode 28. The welding electrodes 24, 28 can be composed of a suitable copper alloy material such as the copper-zirconium alloy that commonly goes by the designation C15000; of course, other materials are possible. As generally known, when performing resistance spot welding, the welding gun arms 18, 20 clamp their respective welding electrodes 24, 28 against opposite sides and outer surfaces of the overlaid workpieces 14, 16 at a weld site 30, with accompanying weld faces of the electrodes aligned across from each other. A faying interface 32 is located between the steel and aluminum workpieces 14, 16 at confronting and abutting inner surfaces of the workpieces.

FIG. 2 illustrates a microstructure of a weld nugget 34 formed via a resistance spot welding process without the use of a protuberance like the ones detailed below. While a suitable weld nugget may be produced in some instances without using a protuberance, in this example defects D have been discovered at and laterally dispersed along the faying interface 32. Among other possibilities, the defects D may include shrinkage, gas porosity, oxide residue, and micro-cracking. When present and dispersed laterally along the faying interface 32, it has been found that the defects D may reduce the peel strength of the weld nugget 34 and may, more generally, negatively impact and weaken the overall integrity of the metallurgical joint established between the steel and aluminum workpieces 14, 16. Moreover, in addition to the defects D, one or more Fe—Al intermetallic layers (not identified) may grow between the steel and aluminum workpieces 14, 16 and at the faying interface 32. The Fe—Al intermetallic layers can consist of FeAl₃, Fe₂Al₅, Fe₂Al₇, as well as other compounds, and when present are often hard and brittle. Again here, the Fe—Al intermetallic layers can have a negative impact on the overall integrity of the joint established between the workpieces 14, 16.

Although not intending to be confined to particular theories of causation, it is currently believed that the dissemination of the defects D laterally along the faying interface 32 is due in large part to the solidification behavior of the weld nugget 34. That is, a heat imbalance can develop between the much hotter steel workpiece 14 and cooler aluminum workpiece 16 because of the dissimilar physical properties of the two metals—namely, the much greater electrical resistivity and thermal resistivity of the steel. The steel therefore acts as a heat source, while the aluminum acts as a heat conductor. The molten weld pool at the aluminum workpiece 16 cools and solidifies from its outer surface in brief contact with the typically cooler (e.g., water cooled) welding electrode toward its inner surface and toward the faying interface 32. The path and direction of a solidification front is represented generally in FIG. 2 by broken arrows P, and a boundary of the weld nugget 34 is represented generally by broken lines B. The path P is pointed at the faying interface 32 and the slanted boundary B is the result of solidification toward the faying interface. Directed this way, any defects D may be driven toward the faying interface 32 as the solidification front progresses along path P, and may end up situated at and laterally along the faying interface.

It is also currently believed that the unwanted solidification behavior and attendant defect dissemination laterally along the faying interface 32 is due in part to an unconcentrated electrical current flow and broad range of heat generation H. The range of heat generation H is represented in FIG. 2 by the horizontal area taken between the vertical broken lines H. Amid the performance of a resistance spot weld, the current flow and heat generation H extend across a relatively wide expanse at the faying interface 32. Furthermore, it is currently believed that the growth of the Fe—Al intermetallic layer(s) is due in part or more to the increased temperature experienced by the steel workpiece 14 during the resistance spot welding process.

FIG. 3 is a photograph of a resistance spot weld RSW on the steel workpiece 14 after the aluminum workpiece 16 has been physically peeled off and away from the steel workpiece 14 during peel strength testing. In this case, the steel workpiece 14 lacked a protuberance like the ones described below. Peel strength testing generally involves pulling one workpiece away from another workpiece after the workpieces are joined together by resistance spot welding until the workpieces are completely pulled apart and separated from each other. The photograph of FIG. 3 is of an inner surface 36 of the steel workpiece 14 that, before the aluminum workpiece 16 was peeled off of the steel workpiece, confronted the aluminum workpiece's inner surface at their faying interface 32. In this peel strength test, the steel and aluminum workpieces 14, 16 separated along their faying interface 32, meaning that the joint failed at that interface. The faying interface 32 is the darker circle shape shown in the photograph. This is generally regarded as an unacceptable resistance spot weld since the weakest part of the weld was determined to be at the faying interface 32 by the peel strength test. It is currently believed that the failure at the faying interface 32 was due to one or more of the following: i) improper wetting between the steel and aluminum workpieces 14, 16 because of oxide layers present on the aluminum workpiece's inner surface, ii) the dissemination of defects laterally along the faying interface, like that depicted in FIG. 2, and/or iii) the formation of Fe—Al intermetallic layers at the faying interface.

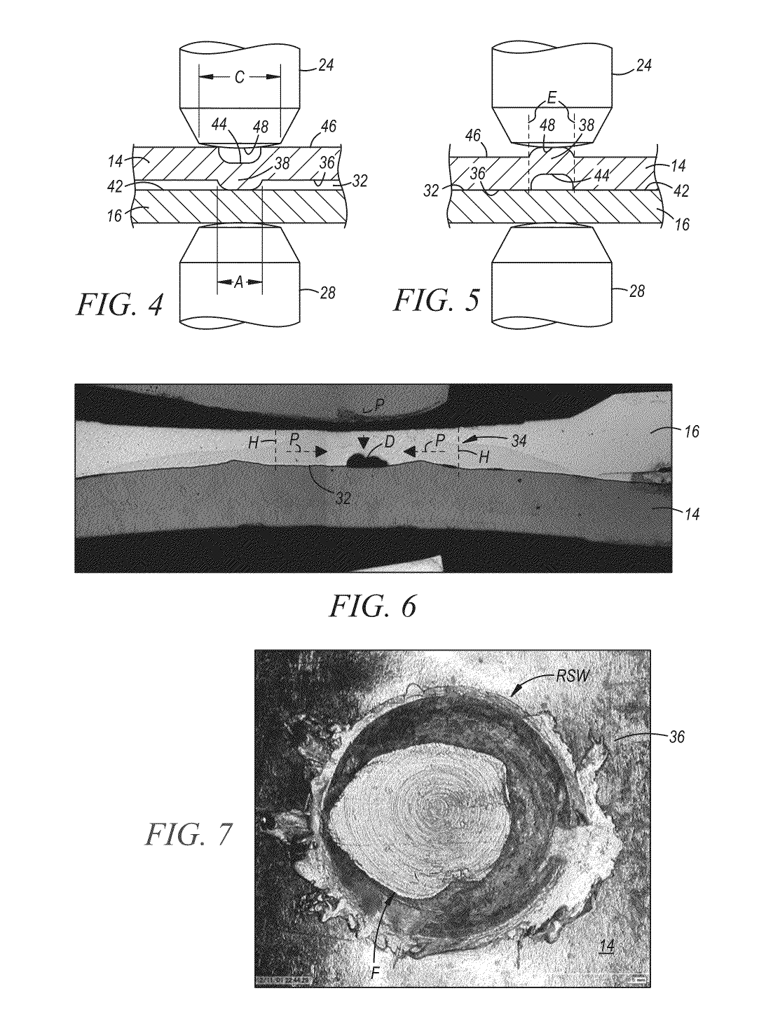

Referring now to FIGS. 4 and 5, in order to address and in some cases resolve one of more of the above shortcomings, a protuberance 38 is formed in the steel workpiece 14 at a future weld site. In the embodiment of FIG. 4, the protuberance 38 is located at the inner surface 36 and juts above a section of the inner surface immediately surrounding the protuberance 38. The inner surface 36 directly confronts an inner surface 42 of the aluminum workpiece 16. When brought together for a resistance spot weld, the inner surfaces 36, 42 come into abutment or near abutment with each other to constitute the faying interface 32 between the steel and aluminum workpieces 14, 16. In this embodiment, an indentation 44 is formed in an outer surface 46 of the steel workpiece 14 as a result of the protuberance 38. Here, the indentation 44 directly confronts a weld face 48 of the first welding electrode 24. The aluminum workpiece 16, in contrast to the steel workpiece 14, is without similar protuberances or indentations at the section depicted in the figures. In the embodiment of FIG. 5, the protuberance 38 is located at the outer surface 46 and juts above a section of the outer surface immediately surrounding the protuberance. The indentation 44 is formed in the inner surface 36 as a result of the jutting protuberance 38. Here, the protuberance 38 directly confronts the weld face 48 of the first welding electrode 24, while the indentation 44 directly confronts the inner surface 42 of the aluminum workpiece 16.

In any of the embodiments detailed in this description, the protuberance 38 can jut vertically above its immediately surrounding surface (inner or outer surface) by different amounts. For example, the protuberance 38 can jut to a height that is less than the thickness of its accompanying workpiece (e.g., less than 1 mm for a 1 mm thick workpiece), or more specifically can jut to a height than is greater than 0.1 mm. Of course, other vertical heights for the protuberance 38 are possible.

When viewed from above and at the inner surface 36 (embodiment of FIG. 4) or outer surface 46 (embodiment of FIG. 5), the protuberance 38 can have different shapes. In the embodiment of the Figures, the protuberance 38 has a generally dome shape, but could also be shaped as a square, rectangle, oval, triangle, infinity symbol, or some other shape. In any of these examples, a largest extent A spanning across the protuberance 38 can be less than a diameter C of the weld face 48 (dimensions A and C shown in FIG. 4). Satisfying this relationship in some instances facilitates the possible improvements set forth briefly above and described below in greater detail, but not all embodiments of the protuberance need fulfill the relationship. In the example of the dome shape, the largest extent A is the dome's diameter and can have a value of approximately 3.0 millimeters (mm) or could have some other value. And in some examples, the diameter C of the weld face 48 can have a value ranging between approximately 6 mm and 12 mm; of course other diameter values are possible. As another example, the largest extent of the square shape would be its corner-to-corner diagonal length.

The protuberance 38 promotes proper wetting between the steel workpiece 14 and the aluminum workpiece 16 by facilitating the penetration of oxide layers present on the inner surface 42 of the aluminum workpiece. It has been determined that the penetration is brought about by concentrated electrical current flow, focused heat generation, or more forceful physical engagement, or a combination of these. Electrical current flow exchanged between the first and second welding electrodes 24, 28 passes through the steel workpiece 14 and initially through the aluminum workpiece 16 via the protuberance 38. This is depicted in FIG. 5 by broken lines E. This is a more concentrated electrical current flow than which occurs without the protuberance 38 since the protuberance furnishes a narrower path for electrical current than without. With no protuberance, the broken lines E representing electrical current flow would have greater horizontal separation in FIG. 5. The more concentrated current flow more easily penetrates through oxide layers at the inner surface 42.

Likewise, heat generated at the steel and aluminum workpieces 14, 16 in response to the electrical current flow is more focused. This is also roughly represented in FIG. 5 by broken lines E. The focused heat generation is in response to the concentrated electrical current flow and more easily penetrates through oxide layers at the inner surface 42. Lastly, depending on its exact design, the protuberance 38 can more forcefully engage the oxide layers at the inner surface 42 and thereby penetrate through them. In the example of FIG. 4, when the welding electrodes 24, 28 are clamped down over the workpiece stack-up 10, the force exerted to the protuberance 38 physically drives the harder steel at the protuberance into the softer aluminum workpiece 16. Oxide layers at the inner surface 42 are hence breached and fractured. In the example of FIG. 5, upon clamping, the protuberance 38 may deform under the exerted force. The protuberance 38 may be flattened out in a direction toward the inner surface 42, and may even be driven physically into the aluminum workpiece 16 to breach and fracture oxide layers. In one specific example, the protuberance 38 of FIG. 5 may deform into a ring shape jutting above the inner surface 36; the ring drives into the softer aluminum workpiece 16 and through any oxide layers present. The protuberance 38 of FIG. 4 may also flatten somewhat under the exerted force. These actions, when occurring alone or all together, promote breakdown of the oxide layers on the aluminum and proper wetting between the steel workpiece 14 and the aluminum workpiece 16.

In addition to penetrating through oxide layers, the protuberance 38 and its accompanying concentrated current flow and focused heat alter the solidification behavior of the molten weld pool forming the weld nugget 34, and thereby limit or altogether preclude the dissemination of defects laterally along the faying interface 32. As shown in FIG. 6, any defects D migrate toward and settle at a central region of the weld nugget 34 instead of laterally along the faying interface 32. Because the current flow is more concentrated and the heat more focused, the range of heat generation H in FIG. 6 extends across a narrower expanse than that of FIG. 2. In other words, the current flow and heat generation is more vertical in FIG. 6 (with protuberance 38) than FIG. 2 (without protuberance 38), and less horizontal. This changes the cooling action of the molten weld pool as it solidifies to become the weld nugget 34 within the aluminum workpiece 16. The molten weld pool cools and solidifies from an exterior region of the aluminum workpiece 16 toward the central region. The path and direction of the solidification front is represented generally in FIG. 6 by broken arrows P. Amid solidification in FIG. 6, any defects D hence migrate toward and settle at the central region and somewhat at a single spot, as opposed to disseminating laterally (i.e., horizontally in FIG. 6) at multiple spots along the faying interface 32.

Moreover, the concentrated current flow and focused heat generation enables a reduction in the electrical current level exchanged between the welding electrodes 24, 28. The total amount of heat generated is reduced as a result. This minimizes diffusion between Fe and Al and thereby minimizes the size and thickness of any Fe—Al intermetallic layers that may form at the faying interface 32. It has been determined that the greater the size and thickness of Fe—Al intermetallic layers, the more brittle the layers. Furthermore, in embodiments that present a non-linear and non-uniform faying interface 32 such as the embodiment of FIG. 4, micro-crack propagation is inhibited. Micro-cracking is one of the undesirable defects D. In general, micro-cracks tend to naturally spread forth in flat planes that appear as straight lines in cross-section. Because the protuberance 38 in some cases introduces a non-planar and non-uniform faying interface 32, micro-cracks that may otherwise spread are inhibited from doing so.

These actions—penetrated oxide layers, altered solidification, minimized Fe—Al intermetallic layers, and inhibited micro-cracks—when occurring singly, in combination, or all together, ultimately help obtain suitable peel strength and help ensure the overall strength and integrity of the joint established between the steel and aluminum workpieces 14, 16. FIG. 7 is a photograph similar to that of FIG. 3. In this case, however, the peel strength testing was conducted on a steel workpiece with a protuberance like the ones described above. The steel and aluminum workpieces 14, 16 were not entirely separated at their faying interface 32 as occurred in FIG. 3, and instead the faying interface held at the weld nugget 34 and pulled a so-called button F off of the aluminum workpiece 16. The button F is a piece of the aluminum workpiece 16 and, when pulled out of the workpiece, left a hole in the aluminum workpiece. This is an indication that the joint between the steel and aluminum workpieces 14, 16 has suitable strength and integrity.

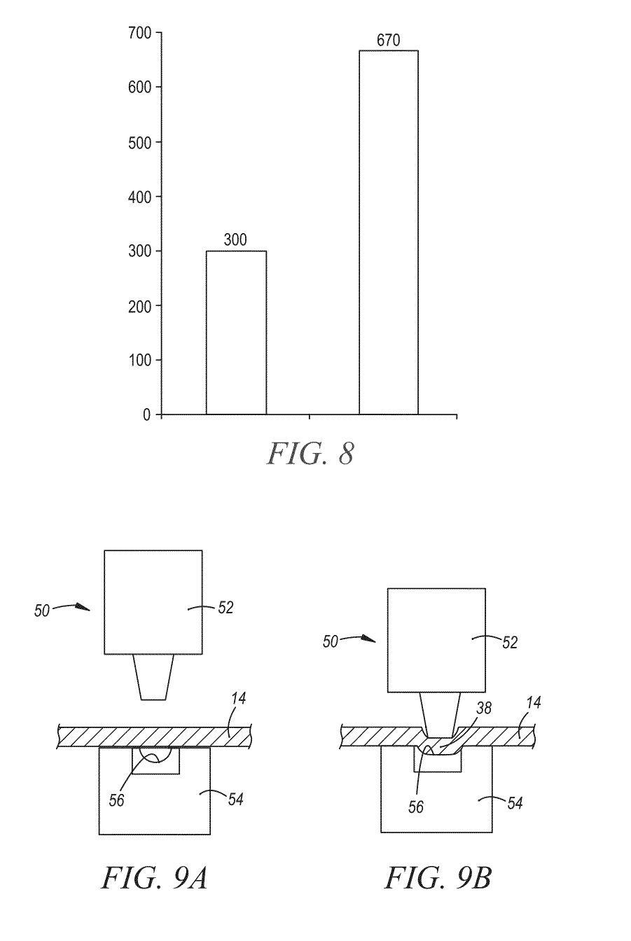

FIG. 8 demonstrates that the average weld strength in shear loading of a joint established between steel and aluminum workpieces with a protuberance exceeds the minimally-required weld strength by more than two times (2x). In the graph, average weld strength measured in pounds (lb) is plotted along the y-axis. The minimum average weld strength needed in this example data is approximately 300 pounds for an aluminum resistance spot weld (left-hand side bar), while the joint with the protuberance exhibits an average weld strength of approximately 670 pounds (right-hand side bar). Such sheer strength of the weld joint (i.e., right-hand side bar) is significantly greater than the minimum required sheer strength of 300 lb as specified by SAE aerospace material specification AMS-W-6858A for an aluminum alloy workpiece of the same gauge (i.e., left-hand side bar). The average weld strengths of the graph were determined by shear testing on workpieces 14, 16 like the ones depicted in FIGS. 4 and 5. Of course, not all tests will necessarily yield data like that of FIG. 8; different protuberance embodiments will yield average weld strengths above and below 670 pounds, and minimally-required average weld strengths could be above and below 300 pounds.

In embodiments not shown in the Figures, the protuberance can take different forms while still providing one or more of the beneficial actions set forth above. For example, the protuberance could be deposits fixed to and extending from the inner surface 36, could be a knurling pattern on the steel workpiece's inner surface, or could be some other structure. The term “protuberance” is used broadly herein as a genus term that encompasses all of these forms. And depending on the embodiment, the protuberance 38 can be formed in the steel workpiece 14 by different processes. For the embodiments of FIGS. 4 and 5, the protuberance 38 can be formed by a metalworking process such as a stamping or coining process. The stamping process is schematically depicted in FIGS. 9A and 9B. A machine press 50 includes an upper press 52 that is forcibly driven down on top of a lower press 54. The upper press 52 displaces a portion of the steel workpiece 14 into a recess 56, and thereby forms the protuberance 38. These types of stamping processes, as well as others, are well known. Other formation processes include cold spray technologies for making the deposit embodiment, or a fusion process such as a laser or arc welding procedure.

In all of the embodiments detailed thus far, the first and second welding electrodes 24, 28 do not need to undergo any particular modifications in order to be used with workpieces having the protuberance 38. This means that the first and second welding electrodes 24, 28 can also be used when spot welding steel-to-steel workpieces and aluminum-to-aluminum workpieces, in addition to the steel-to-aluminum workpieces described above. This furnishes the flexibility desired and oftentimes needed for resistance spot welding vehicle body panels in an automotive manufacturing facility. Or, the welding electrodes can be changed for the particular workpieces to be welded. For steel-to-steel workpieces, for example, the welding electrodes can have a weld face diameter of approximately 5 mm to 10 mm with a radii of curvature between approximately 40 mm and flat. For aluminum-to-aluminum workpieces, for example, the welding electrodes can have a weld face diameter of approximately 6 mm to 20 mm, and more preferably approximately 8 mm to 12 mm, with a radii of curvature from approximately 12 mm to 150 mm, and more preferably approximately 20 mm to 50 mm. For aluminum-to-aluminum workpiece resistance spot welding, the weld face may have surface features to penetrate oxide layers formed on the aluminum surface. For example, if desired, the weld face can be textured or have surface features such as those described in U.S. Pat. Nos. 6,861,609; 8,222,560; 8,274,010; 8,436,269; and 8,525,066, and in U.S. Patent Application Publication No. 2009/0255908, and in U.S. application Ser. No. 13/783,343. For welding aluminum-to-aluminum workpieces and steel-to-steel workpieces, it has been found that welding electrodes with radii of curvature of 20 mm to 50 mm works well in some instances.

The above description of preferred exemplary embodiments and related examples are merely descriptive in nature; they are not intended to limit the scope of the claims that follow. Each of the terms used in the appended claims should be given its ordinary and customary meaning unless specifically and unambiguously stated otherwise in the specification.

1. A method of resistance spot welding a steel workpiece and an aluminum or aluminum alloy workpiece together, the method comprising:
providing a workpiece stack-up that includes a steel workpiece and an aluminum or aluminum alloy workpiece;
forming a protuberance in the steel workpiece, the protuberance jutting above a surface of the steel workpiece surrounding the protuberance;
providing a first welding electrode generally confronting the steel workpiece at the protuberance and a second welding electrode generally confronting the aluminum or aluminum alloy workpiece;
clamping the first and second welding electrodes over the workpiece stack-up and over the protuberance; and
performing at least one individual resistance spot weld to the workpiece stack-up at the protuberance.

2. The method as set forth in claim 1, wherein the protuberance intensifies clamping pressure exerted to the steel and aluminum or aluminum alloy workpieces at the protuberance upon clamping the first and second welding electrodes over the workpiece stack-up, and helps penetrate oxide layers present on an inner surface of the aluminum or aluminum alloy workpiece that confronts the steel workpiece.

3. The method as set forth in claim 1, wherein the protuberance concentrates the flow of electrical current exchanged between the first and second welding electrodes at the protuberance during a resistance spot welding event, and the protuberance facilitates the flow of electrical current through oxide layers present on an inner surface of the aluminum or aluminum alloy workpiece that confronts the steel workpiece.

4. The method as set forth in claim 1, wherein the protuberance focuses heat generation at the protuberance upon performance of the at least one individual resistance spot weld, and the generated heat alters solidification behavior of a weld pool produced via the at least one individual resistance spot weld.

5. The method as set forth in claim 1, wherein forming the protuberance in the steel workpiece includes forming the protuberance via a metalworking process carried out to the steel workpiece.

6. The method as set forth in claim 1, wherein forming the protuberance in the steel workpiece includes forming the protuberance via a fusion process carried out to the steel workpiece.

7. The method as set forth in claim 1, wherein forming the protuberance in the steel workpiece includes forming the protuberance via a cold spraying process carried out to the steel workpiece.

8. The method as set forth in claim 1, wherein a value of a largest extent of the protuberance is less than a diameter of a weld face of the first welding electrode.

9. The method as set forth in claim 8, wherein the largest extent of the protuberance is a diameter of approximately 3 millimeters (mm).

10. The method as set forth in claim 1, wherein the protuberance has a generally dome shape in cross-sectional profile.

11. The method as set forth in claim 1, wherein the protuberance juts above an inner surface of the steel workpiece, the inner surface confronting the aluminum or aluminum alloy workpiece.

12. The method as set forth in claim 1, wherein the protuberance juts above an outer surface of the steel workpiece, the outer surface confronting the first welding electrode.

13. The method as set forth in claim 1, further comprising:
taking the workpiece stack-up away from the first and second welding electrodes after the performance of the at least one individual resistance spot weld;
providing a second workpiece stack-up that includes a first steel workpiece and a second steel workpiece, or that includes a first aluminum or aluminum alloy workpiece and a second aluminum or aluminum alloy workpiece;
clamping the first and second welding electrodes over the second workpiece stack-up; and
performing at least one second individual resistance spot weld to the second workpiece stack-up.

14. A welding electrode and workpiece stack-up assembly for resistance spot welding the workpiece stack-up together, the assembly comprising:
a first welding electrode;
a second welding electrode;
a steel workpiece generally confronting the first welding electrode, the steel workpiece having a protuberance jutting above a surface of the steel workpiece surrounding the protuberance, a largest extent of the protuberance having a value less than a diameter of a weld face of the first welding electrode; and
an aluminum or aluminum alloy workpiece generally confronting the second welding electrode on one side and generally confronting the steel workpiece on an opposite side.

15. The welding electrode and workpiece stack-up assembly as set forth in claim 14, wherein the protuberance juts above an inner surface of the steel workpiece, the inner surface confronting the aluminum or aluminum alloy workpiece.

16. The welding electrode and workpiece stack-up assembly as set forth in claim 14, wherein the protuberance juts above an outer surface of the steel workpiece, the outer surface confronting the first welding electrode.

17. The welding electrode and workpiece stack-up assembly as set forth in claim 14, wherein the largest extent of the protuberance is a diameter of approximately 3 millimeters (mm).

18. The welding electrode and workpiece stack-up assembly as set forth in claim 14, wherein the protuberance intensifies clamping pressure exerted to the steel and aluminum or aluminum alloy workpieces at the protuberance upon clamping the first and second welding electrodes over the workpiece stack-up during the performance of a resistance spot weld, and the protuberance helps penetrate oxide layers present on an inner surface of the aluminum or aluminum alloy workpiece that confronts the steel workpiece.

19. The welding electrode and workpiece stack-up assembly as set forth in claim 14, wherein the protuberance concentrates the flow of electrical current exchanged between the first and second welding electrodes at the protuberance during the performance of a resistance spot weld, and the protuberance facilitates the flow of electrical current through oxide layers present on an inner surface of the aluminum or aluminum alloy workpiece that confronts the steel workpiece.

20. The welding electrode and workpiece stack-up assembly as set forth in claim 14, wherein the protuberance focuses heat generation at the protuberance during the performance of a resistance spot weld, and the generated heat alters solidification behavior of a weld pool produced via the resistance spot weld.
